(19) United States
(12) Patent Application Publication
(10) Pub. No.: US 2022/0184499 A1
(43) Pub. Date: Jun. 16, 2022

(54) VIDEO GAME WITH MAP-BASED FEATURES

(71) Applicants: Thomas Wilson, Lake Forest, CA (US); Philippe Turcotte, Los Angeles, CA (US); Dave Bergeron, III, Los Angeles, CA (US); Marc-André Gagné, III, Los Angeles, CA (US)

(72) Inventors: Thomas Wilson, Lake Forest, CA (US); Philippe Turcotte, Los Angeles, CA (US); Dave Bergeron, III, Los Angeles, CA (US); Marc-André Gagné, III, Los Angeles, CA (US)

(21) Appl. No.: 17/644,494

(22) Filed: Dec. 15, 2021

Related U.S. Application Data
(60) Provisional application No. 63/125,526, filed on Dec. 15, 2020.

(51) Int. Cl. A63F 13/65; A63F 13/825

(52) U.S. Cl. CPC A63F 13/65; A63F 13/825

(57) ABSTRACT

A video game may include features to concentrate play of the video game. Play of the video game may be concentrated by continuation of engagement of play by player-controlled game characters and/or modification or effective modification of a map of a virtual world of game play. In some embodiments the video game may provide for an adventure or game object collection quest. In some embodiments collected game objects may displayed in a collection. In some embodiments adjunct real-world related games may be used in an adjunct fashion to the video game.

### CROSS REFERENCE TO RELATED APPLICATION

This application claims the benefit of the filing date of U.S. Provisional Patent Application No. 63/125,526, filed on Dec. 15, 2020, the disclosure of which is incorporated by reference herein.

### BACKGROUND OF THE INVENTION

The present invention relates generally to video games, and more particularly to video games including map-related concentration and/or other features.

Video games provide a source of entertainment for many. Video games often provide an interactive activity that can be interesting, challenging, and may allow game players to engage in simulated activities that may otherwise be unavailable. Often the video games may be multiplayer video games, in which a plurality or even a multitude of game players may interactively play a video game in concert. In some multiplayer video games, the game players may play the video game in competition or in cooperation with one another, or both.

Enjoyment of play of the video game may be dependent on a variety of factors, some of which may vary over time, even during play of a single video game. In some cases the challenges presented to game players, challenges that may include interactions between player-controlled game character, may be one of those factors. Providing an appropriately challenging video game may be difficult, however. Skill levels of game players and how well those game players play at any given time may vary. With such variations, providing an appropriate magnitude of challenges, and the frequency at which those challenges occur, may be difficult to implement.

### BRIEF SUMMARY OF THE INVENTION

Some embodiments provide a method of concentrating game play of a video game, comprising: determining a metric associated with passage of game characters past at least one gating construct in play of a video game; based on the metric, determining a subset of the game characters to continue in play of the video game; and continuing to provide for play of the video game with game characters that are in the subset of the game characters and discontinuing providing play of the video game with game characters that are not in the subset of game characters.

Some embodiments provide a method of modifying a map of a video game world during play of a video game, comprising: determining that a map modification triggering event has occurred during play of a video game, the video game providing play in a video game world; and in response to determining that the map modification triggering event has occurred, successively making unplayable interior-most playable areas of portions of the video game world.

These and other aspects of the invention are more fully comprehended upon review of this disclosure.

### BRIEF DESCRIPTION OF THE FIGURES

FIG. 1A illustrates a networked video game system in accordance with aspects of the invention.

FIG. 1B illustrates a game device and a map of a virtual world of game play on a display of the game device, in accordance with aspects of the invention.

FIG. 2 is a flow diagram of a process for concentrating game characters engaged in game play of a video game, in accordance with aspects of the invention.

FIG. 3 is a flow diagram of a process for modifying a virtual world of game play based on a triggering event, in accordance with aspects of the invention.

FIG. 4 illustrates a virtual world of game play modified in response to a triggering event, in accordance with aspects of the invention.

FIG. 5 is a floorplan of a collection area in accordance with aspects of the invention.

FIG. 6 is a map of for a geocaching adjunct game, in accordance with aspects of the invention.

### DETAILED DESCRIPTION

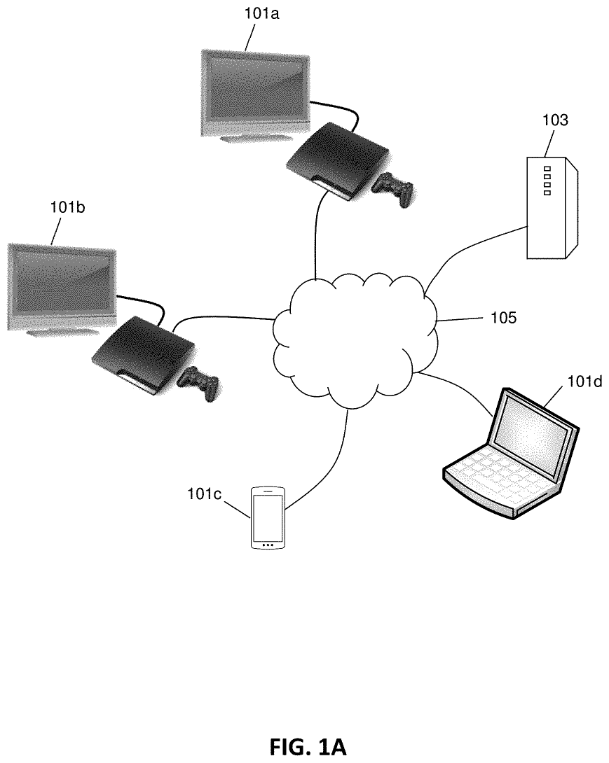

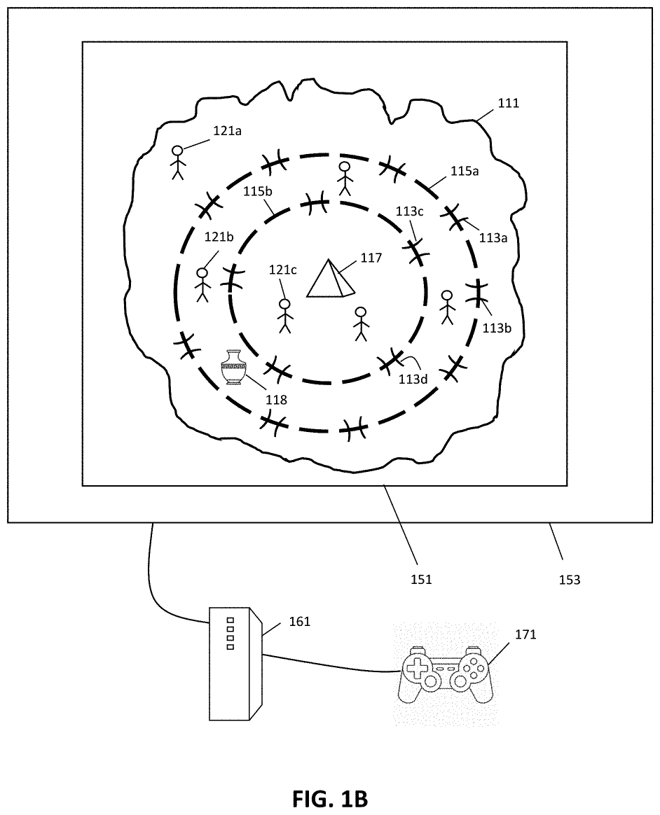

FIG. 1A is a semi-block diagram of a system in accordance with aspects of the invention. The system includes a plurality of game devices 101a-d coupled to each other and a game server 103 over a network 105, which may be for example the Internet. The game devices, and the server, may be considered compute devices.

The game devices 101a and 101b are shown as including a game console having at least one processor, a game controller, and a display. The game device 101c is shown as a smartphone, including at least one processor, a display device, and a touchscreen. The game device 101d is shown as a personal computer, of the laptop type in FIG. 1A. More generally, in various embodiments the game devices may instead or in addition comprise a personal computer, a tablet computer, a smart phone, and/or some other compute device, each configured for video game play. In addition, for purposes of illustration, only a small number of game devices are shown in FIG. 1A, in some embodiments the number of game devices may be over ten, and in some embodiments may be an order of magnitude or orders of magnitude greater than that.

The game devices are configured for play of a multiplayer video game. During play of the video game, a game player utilizes the game controller or other input devices of a game device to control actions of a game character associated with the game player. Such a game character may therefore be considered a player-controlled game character. The game character, responsive to commands provided by the game controller, is in and interacts with a virtual world and its other inhabitants. Some of the other inhabitants may be player-controlled game characters controlled by other game players. Some of the other inhabitants may be game characters controlled by the video game itself, and such game characters may be considered game-controlled game characters.

The game server receives information regarding game play status from the game devices, with the game server distributing the game play status to the various game devices. In some embodiments the game server may instead receive requests for game character actions from the game devices, with the game server determining game play status and distributing information regarding game play status to the game devices.

In some embodiments the game server may receive some information regarding game play status from the game devices, with the game server determining other information regarding game play status. For example, in some embodiments the game server may determine playable areas of the virtual world, and in some embodiments the game server may determine game characters available to engage in play in the virtual world. In some embodiments the game characters available to engage in play of the virtual world are those game characters in the playable areas of the virtual world. In some embodiments the game server may determine playable areas of the virtual world based on game play status provided from the game devices. In some embodiments the game server may determine playable areas of the virtual world based on information provided by the game devices as to player-controlled game characters that have passed through or beyond a gating construct of the virtual world.

In some embodiments, however, the game devices, or a one of them or an any one of them, may determine the playable areas of the virtual world based on game status developed by the one of the game devices and the game status received from others of the game devices.

In some embodiments the video game may be a game in which game players utilize player-controlled game characters to attempt to obtain a special game item located in a predetermined location in the virtual world. In some such embodiments the player-controlled game characters may be required to collect other game items and/or pass through or beyond gating constructs of the virtual world while en route to the predetermined location.

In some embodiments, play of the video game may be concentrated while the game characters are en route to the predetermined location. In some embodiments the game play is concentrated by reducing areas of the virtual world available for game play, which in some embodiments is on a temporary basis. In some embodiments play of the video game may be concentrated by limiting further engagement in game play to particular player-controlled game characters. In some embodiments the particular player-controlled game characters are those within the areas of the virtual world available for game play after reducing of the areas of the virtual world available for game play. In some embodiments the particular player-controlled game characters are those that have passed through a predetermined number of gating constructs of the virtual world. In some embodiments the particular player-controlled game characters are those that have passed through a predetermined number of gating constructs of the virtual world and player-controlled game characters that are on a same team as the particular player-controlled game characters are those that have passed through the predetermined number of gating constructs of the virtual world. In some embodiments the gating constructs are virtual gates in the virtual world. In some embodiments the gating constructs are predetermined locations or areas in the virtual world. In some embodiments player-controlled game characters may only pass through a gating construct in the virtual world with possession of a virtual item, for example a virtual relic or artifact.

In some embodiments, interior-most playable areas of the virtual world are made unplayable based on a triggering event. In some embodiments the triggering event is attainment of a goal of the video game. In some embodiments the goal is obtaining possession of a predetermined virtual game item by a player-controlled game character. In some embodiments the predetermined virtual game item is at a predetermined location in the virtual world. In some embodiments the predetermined location is at or about a central location of the virtual world. In some embodiments a most interior-most playable area is made unplayable. In some embodiments subsequently a next-most interior-most playable area is made unplayable. In some embodiments successive interior-most playable areas are successively made unplayable, until no areas remain to be made unplayable.

FIG. 1B illustrates a game device and a map of a virtual world of game play on a display of the game device. In some embodiments the game device may be one of the game devices of

FIG. 1A, and in some embodiments the game device may be coupled to a network, for example the network of FIG. 1A, with other game devices also coupled to the network to allow for multiplayer play of a video game. The game device is shown as including a computer console 161 with an associated display device 153 and an associated game controller 171. The display device is shown as displaying a display 151, with a map of a virtual world of game play shown on the display.

The map of the virtual world shows an island 111. In some embodiments the map may show other landforms, seaforms, or other forms. The island is roughly circular in shape in FIG. 1B, although in various embodiments the island, or other features, may be shaped differently. The island includes a plurality of first gating constructs, for example gating constructs 113a and 113b, arranged in a first ring 115 slightly away from a shoreline of the island. A plurality of second gating constructs, for example, gating constructs 113c and 113d, are arranged in a second ring 115b, interior to the first ring 115a.

The gating constructs in FIG. 1B are illustrated as passes, and in some embodiments the gating constructs, or at least some of them, may be passes in a physical landform. In some embodiments the gating constructs may be gates, obstacles, or some other construct which may be passed by or through by player-controlled game characters. In some embodiments the gating constructs may be considered a control point or area, a point or area by or through which player-controlled game characters are to pass.

The display also shows locations of game characters, for example game characters 121a-c, in the virtual world. As an example, a first game character 121a may be associated with a game player associated with a remote game device coupled to the network. A second game character 121b may be associated with some other game player, also associated with a remote game device coupled to the network. A third game character 121c may be associated with a game player using the game device of FIG. 1B. During game play, player-controlled game characters, for example game characters 121a-c, may be caused by game players, for example using game controllers, to pass through the gating constructs. In some embodiments areas of the virtual world are cordoned off other than at the gating constructs. For example, in some embodiments areas of the virtual world interior to the first ring may only be reached by game characters through passage through a gating construct in the first ring. Similarly, for example, in some embodiments areas of the virtual world interior to the second ring may only be reached by game characters through passage through a gating construct in the second ring. In other embodiments, however, various areas of the virtual world, or all areas in some embodiments, may be freely accessible to game character—with points or other rewards or benefits provided when game characters pass through the gating constructs.

The map of FIG. 1B includes a goal location, a location to which the game characters aim to arrive. The goal location in FIG. 1B is located at a center of the island, and is in the form of a pyramid 117. In various embodiments the goal location may be in the form of some other structure, for example a temple, or, in some embodiments, simply the location at which a particular game item may be located. In some embodiments the goal location is the location of a game item, retrieval of which by a player-controlled game character is a goal, in some embodiments the primary goal, of game play.

In some embodiments play of the video game begins with the player-controlled game characters at a periphery of a playable area of the virtual world, for example a shoreline of the island of FIG. 1B. During play, the player-controlled game characters are to attempt to obtain a game item located at a goal location in the virtual world, and bring the game item back to the periphery of the playable area. The game item may be an artifact or some other item. The goal location may be, as in FIG. 1B, a structure at a center of the playable area.

While en route to the goal location, the player-controlled game characters may pass through the gating constructs. In some embodiments, passage through gating constructs may be a factor in determining player-controlled game characters which may continue engagement in the play of the game. For example, in some embodiments after a predetermined number of player-controlled game characters have passed through a set of gating constructs, only those player-controlled game characters may continue to be engaged in play of the game. In some embodiments, after a predetermined number of player-controlled game characters have passed through a set of gating constructs, only those player-controlled game characters and player-controlled characters on a same team as the player-controlled game characters that have passed through the set of gating constructs may continue to be engaged in play of the game.

For example, in the context of FIG. 1B, after five player-controlled game characters have passed through gating constructs of the first ring, as shown in FIG. 1B, only those five player-controlled game characters will continue engagement in game play. The player-controlled game character 121a, not having passed through any of the gating constructs of the first ring, would not continue to be engaged in game play. In some embodiments, however, both player-controlled game characters that have passed through the gating constructs and player-controlled game characters on a same team as those that have passed through the gating constructs may continue to be engaged in game play. In such circumstances, if player-controlled game character 121a were on a same team as either player-controlled game characters 121b or 121c, then player-controlled game character 121a would also continue to be engaged in game play.

Similarly, for example, after two player-controlled game characters have passed through gating constructs of the first ring, as shown in FIG. 1B, only those two player-controlled game characters will continue engagement in game play. The player-controlled game characters 121a and 121b, not having passed through any of the gating constructs of the second ring, would not continue to be engaged in game play. In some embodiments, however, both player-controlled game characters that have passed through the gating constructs and player-controlled game characters on a same team as those that have passed through the gating constructs may continue to be engaged in game play. In such circumstances, if player-controlled game characters 121a and 121b were on a same team as player-controlled game character 121c, then player-controlled game characters 121a and 121b would also continue to be engaged in game play.

In some embodiments how well a game player is playing the video game at the time may be indicated by the game player's player-controlled game character passing through the gating constructs. That a game player's game character has passed through gating constructs may be a function of the game player's skill, luck, how well the game player is playing on a particular day, or other factors. Continuing play of the video game based on or only with player-controlled game characters that have passed through the gating constructs, may therefore possibly be considered to concentrate or distill play of a particular instantiation of play of the video game, in some embodiments.

The map of FIG. 1B also shows a relic, in the form of a vase 118, between the first ring and the second ring. The relic is a game item. Although only a single relic is shown, in some embodiments a plurality of relics may be variously located about the virtual world. In some embodiments the relics may be collected or used by player-controlled game characters during a course of play of the video game. In some embodiments passage by player-controlled game characters through one or more gating constructs may require possession or use of one or more relics. In some embodiments passage by player-controlled game characters through one or more gating constructs may be assisted by or made easier by possession of one or more relics.

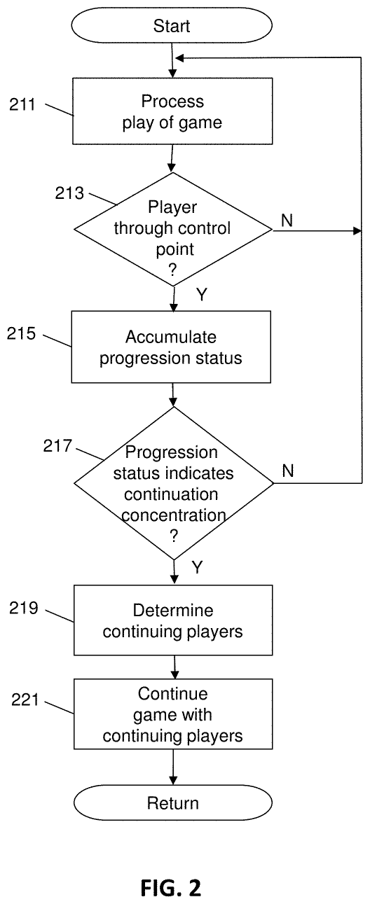

FIG. 2 is a flow diagram of a process for concentrating game characters engaged in game play of a video game. In some embodiments the process is performed by the system of FIG. 1A. In some embodiments the process, or part of the process, is performed by a server, for example the game server of FIG. 1A. In some embodiments the process, or part of the process, is performed by a game device, for example a game device of FIG. 1A. In some embodiments the process is performed by one or more processors, for example configured by program instructions. In some embodiments the process of FIG. 2, or parts of the process subsequent to operation of block 211, is performed separately for each control point in a video game. In some embodiments the process of FIG. 2, or parts of the process subsequent to operation of block 211, is performed separately for each set of control points in a video game. In some embodiments the process of FIG. 2 is commonly performed for all of the control point in a video game.

In block 211 the process provides for game play of the video game. In some embodiments game play of the video game is accomplished with the game player providing user inputs to the game device, for example by way of a game controller or other user input device, to control a player-controlled game character in and interacting with a virtual world. In some embodiments the video game is a multi-player video game, and the game device provides information to a game server as to status of the game and game character, with the game device also receiving from the game server status of the game and other game characters controlled by other game players. In some embodiments, during game play of the video game, the game character is controlled to pass by or through control points, which may be gating constructs. In some embodiments the game character may collect game items, which may be considered relics, during game play. In some embodiments the game character may be controlled to proceed to a goal location in the virtual world, in some embodiments for the purpose of collecting a game item, which may be considered an artifact, at the game location. In some embodiments the gaming character may also be controlled to return to a starting point or other location in the virtual world after collection of the artifact.

In various embodiments the player-controlled game character may be in competition and/or collaboration with various other player-controlled game characters. In some embodiments the player-controlled game characters may be formed into teams, with each of the teams in competition with one another. In some embodiments competition between game characters and/or teams of game characters may be based solely on collection of relics and/or an artifact. In some embodiments competition between game characters and/or teams of game characters may instead or additionally be based on combat between game characters and/or teams of game characters.

In block 213 the process determines if a player-controlled game character has passed by or through a control point. In some embodiments the control point is a predefined location or area in a virtual world of game play. In some embodiments the control point is a gating construct. In some embodiments the gating construct is a gate. In some embodiments the gating construct is an obstacle. In some embodiments the gating construct is a task to be accomplished by a player-controlled game character. In some embodiments the player-controlled game character is required to have possession of a predetermined game item, or at least one of a set of predetermined game items, in order to pass by or through the control point.

If the process determines that a player-controlled game character has passed by or through a control point the process continues to block 215, otherwise the process continues with operations of block 211.

In block 215 the process accumulates status of progress through the control point(s). In some embodiments the process increases a counter indicating a number of player-controlled game characters that have passed through the control point(s). In some embodiments a different counter is used for each control point. In some embodiments a different counter is used for each of a plurality of sets of control points. In some embodiments a single counter is used for all of the control points. In some embodiments the counter is increased monotonically. In some embodiments the counter is increased in a one-to-one relationship with numbers of player-controlled game characters that have passed by or through a control point. In some embodiments the counter is increased as a function of numbers of player-controlled game characters that have passed by or through a control point.

In block 217 the process determines if the status of progress through the control point(s) indicates concentration of continuing play of the video game should occur. In some embodiments the process determines that concentration of continuing play of the video game should occur in response to the counter equaling or exceeding a predetermined number. In some embodiments the process determines that concentration of continuing play of the video game should occur in response to the counter equaling or exceeding a predetermined number and the occurrence of some other event. In some embodiments the predetermined number changes during the course of game play. In some embodiments the predetermined number is a fraction (less than 1) of a number of player-controlled game characters then engaged as part of play of the video game.

If the process determines that concentration of continuing play of the video game should occur, the process continues to block 219. Otherwise the process continues with operations of block 211.

In block 219, the process determines player-controlled game characters to continue to be engaged as part of play of the video game. In some embodiments the process determines that player-controlled game characters that have passed by or through particular control points are the player-controlled game characters that will continue to be engaged as part of play of the video game. In some embodiments the process determines that a predetermined number of player-controlled game characters are to continue to be engaged as part of play of the video game, with the process determining which player-controlled game characters are to continue to be engaged as part of play of the video game based on one or more game metrics. In some embodiments the process determines teams of player-controlled game characters to continue to be engaged as part of play of the video game.

In block 221 the process continues play of the video game with the player-controlled game characters determined to be continuing in play of the video game. In some embodiments, of the player-controlled game characters, only those player-controlled game characters determined to be continuing in play of the video game continue in play of the video game.

The process thereafter returns.

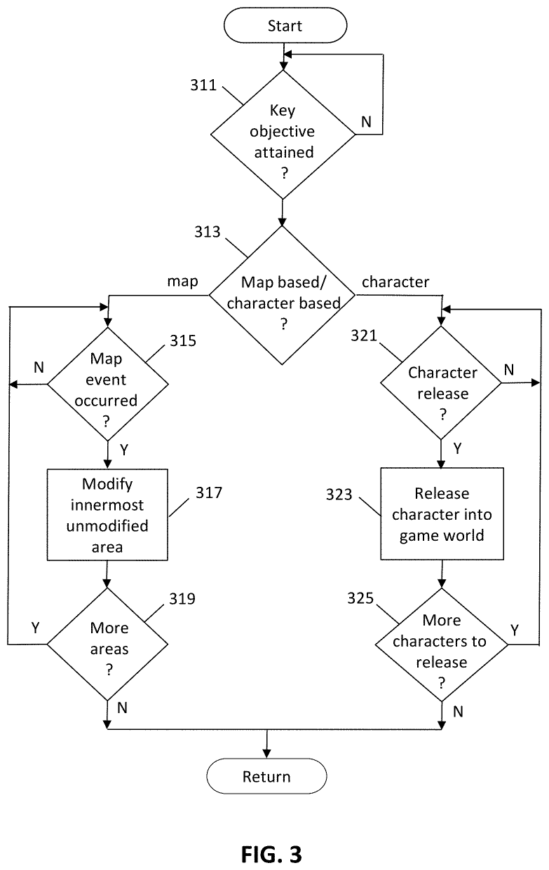

FIG. 3 is a flow diagram of a process for modifying a virtual world of game play based on a triggering event. In some embodiments the process may be considered a further method of concentrating video game play. In some embodiments the process is performed by the system of

FIG. 1A. In some embodiments the process, or part of the process, is performed by a server, for example the game server of FIG. 1A. In some embodiments the process, or part of the process, is performed by a game device, for example a game device of FIG. 1A. In some embodiments the process is performed by one or more processors, for example configured by program instructions.

In block 311 the process determines if a key objective of play of the video game has been obtained. In some embodiments the key objective is accomplishment by a player-controlled game character of a predetermined task. In some embodiments the key objective is a primary objective of the game, or a major objective on a path to the primary objective of the game. In some embodiments the key objective of the game is for a player-controlled game character to obtain a game item, for example in the form of an artifact, from a predetermined location in a virtual world of game play, and, as an ultimate objective of the game, to transport that game item to a predetermined edge of the virtual world of game play. In some embodiments the artifact is located within a temple of a center of an island forming the virtual world of game play, with the player-controlled game character to obtain the artifact and transport it to an edge of the island.

If the key objective has been obtained, the process proceeds to block 313.

In block 313 the process determines if concentration of play of the video game is a map-based concentration or a game-controlled character-based concentration. For a map-based concentration, interior playable areas of the virtual world of game play are made non-playable. For a game-controlled character-based concentration, an unbeatable or extremely difficult to beat game-controlled character is released into the virtual world, effectively making locales near the game-controlled character unavailable for play for player-controlled game characters. In some embodiments the process does not explicitly make the determination of block 313, with the determination predetermined prior to the start of game play—either by user selection or by game developer design. In some embodiments the determination may be otherwise made.

If the concentration of play of the video game is a map-based concentration, the process proceeds to block 315, and continues with blocks 317 and 319. If the concentration of play of the video game is a game-controlled character-based concentration, the process proceeds to block 321, and continues with blocks 323 and 325.

In block 315 the process determines if a map event has occurred. In some embodiments a map event occurs after a predetermined period of time after the key objective has been obtained. In some embodiments the map event occurs when a player-controlled game character with possession of the game item is a predetermined distance from the location at which the game item was obtained, or passes a location or any one of a set of locations after obtaining the game item. If the map event has occurred, the process continues to block 317.

In block 317 the process modifies an innermost unmodified playable area of the virtual world. In some embodiments the process modifies the innermost unmodified playable area by making that area unplayable. In some embodiments the process modifies the innermost unmodified playable area by removing that area from game play, along with all that that area may contain-including in some embodiments any player-controlled game characters that may be within that area.

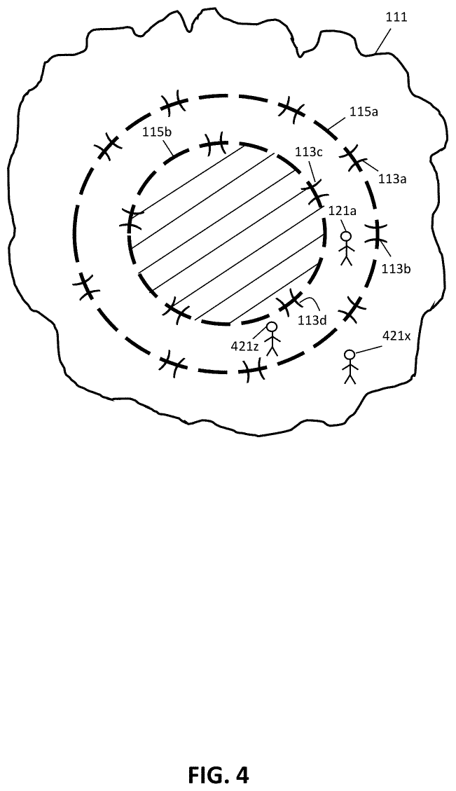

FIG. 4 illustrates a map of a virtual world of game play modified in response to a triggering event, with an innermost playable area made unplayable. The map of FIG. 4 shows the island 111 of FIG. 1B. As in FIG. 1B, the island is roughly circular in shape and includes a plurality of first gating constructs, for example gating constructs 113a and 113b, arranged in a first ring 115 slightly away from a shoreline of the island and a plurality of second gating constructs, for example, gating constructs 113c and 113d, are arranged in a second ring 115b, interior to the first ring 115a. In FIG. 4, an area interior to the second ring has been made unplayable, as represented by cross-hatching in FIG. 4. The player-controlled game characters that remain engaged in game play, in the case of FIG. 4 characters 121a, 421x, 421z, are outside the second ring. These characters may not pass through the second ring into the unplayable area, and, in some embodiments, any player-controlled game characters that were inside the second ring at the time the interior area was made unplayable are no longer engage in game play.

In some embodiments, making of game areas unplayable may proceed in an iterative manner. For example, in block 319 of the process of FIG. 3, the process determines if there are more areas to be modified. In some embodiments more areas remain to be modified if the virtual world includes any playable areas. In some embodiments more areas remain to be modified if any playable areas other than an ultimate playable area remain playable in the virtual world. Returning to the example of FIG. 4, an area between the first ring and the second ring additionally may be made unplayable, and, in some embodiments, the area outside of the first ring may be made unplayable as well.

If more areas remain to be modified, the process continues back to operations of block 315, otherwise the process returns.

If the concentration of play of the video game is determined in block 313 to be a game-controlled character-based concentration, the process proceeds to block 321. In block 321 the process determines if the game-controlled game character should be released. In some embodiments the process may determine to release the game-controlled game character into the virtual world a predetermined time period after the key objective is obtained. In some embodiments the process may release the game-controlled game character into the virtual world as part of a process that occurs with the obtaining of the key objective.

In block 323 the game-controlled game character is released in the virtual world. In some embodiments the game-controlled game character has characteristics and/or capabilities such that player-controlled game characters effectively cannot engage in game play in the vicinity of the game-controlled game character, or at least cannot do so for any extended period of time. For example, in some embodiments the game-controlled game character may be sufficiently fierce and powerful that the game-controlled game character will destroy any player-controlled game characters it encounters.

In block 325 the process determines if there are more game-controlled game characters to release into the virtual world. In some embodiments successive game-controlled game characters may be released, for example on a timed basis. If there are more game-controlled game characters to be released, the process goes back to operations of block 321, otherwise the process returns.

In some embodiments player-controlled game characters may collect a variety of game items during play of the video game. The game items may be, for example, relics and/or artifacts. In some embodiments collection of the relics and/or artifacts may provide assistance or aid to the player-controlled game characters during play of the video game, and/or in some embodiments collection of the relics and/or artifacts may be a purpose of the video game. In some embodiments the collection of the relics and/or artifacts may have no impact on play of the video game, but game players may simply want their player-controlled game characters to collect the relics and/or artifacts nevertheless.

In some embodiments the video game provides a capability for game players to store an indication of game items, for example relics and/or artifacts, collected during game play, and display, on a display of or associated with a game device, those game items in a collection. In some embodiments the collection may only be viewable by the game player whose player-controlled game characters collected the game items, in some embodiments the collection may be viewable by others allowed access to viewing of the collection by the game player, and in some embodiments the collect may be generally viewable by all game players.

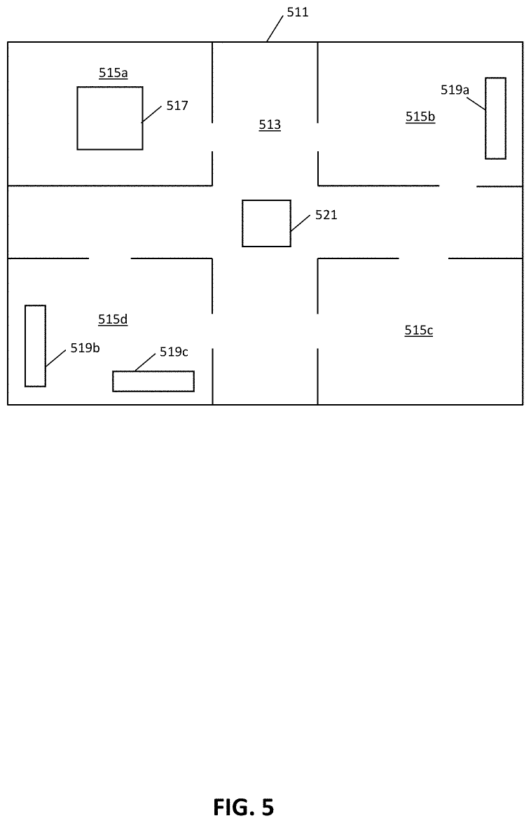

FIG. 5 is a floorplan of a collection area in accordance with aspects of the invention. In some embodiments the collection area may be specific to a particular game player and may be used for display of game items collected by player-controlled game characters of the game player.

In some embodiments, an indication of game items collected by a player-controlled game character is stored. In some embodiments the indication is stored along with an indication of an identity of the player-controlled game character and/or an indication of an identity of the game player with which the player-controlled game character is associated. In some embodiments, an indication of the time, date, and/or gaming session that the game item was acquired by the game player is stored. In some embodiments, an indication of the game item's attributes may be stored, including without limitation, the game item's name, type, alphanumeric identifier, value, rarity, date of introduction into the video game, redemption value, size, etc. In some embodiments, an indication of replay data of the gaming session in which the game item was acquired may be stored. The replay data may comprise all or a portion of the game session (e.g., a replay of the entire game session, a replay of the moments where the game player first obtained the game item, a replay of the completion of the game session, etc.)

In some embodiments the collected game items are all game items collected by the player-controlled game character. In some embodiments the collected game items are game items in the possession of the player-controlled game character at a conclusion of play of each game for that player-controlled game character. In some embodiments the indication(s) are stored by a game device used by the game player, with in some embodiments the indication(s) provided to a game server as well.

The collection area of FIG. 5 is shown as comprising an enclosed indoor area 511. The closed indoor area includes a plurality of rooms 515a-d, with a common walkway 513 separating the rooms. In FIG. 5, the rooms are shown as being at corners of a rectangular enclosed area, with the common walkway forming a central cross within the enclosed area. Various doorways provide access to the rooms from the common walkway. A first of the rooms 515a has a central display stand 517 for display of collected game items. A second of the rooms 515b has a display case 519a about one wall. A third of the rooms 515c has no display cases or stands. A fourth of the rooms includes display cases 519b,c about two exterior walls In various embodiments, however, the collection area may have different shapes and features.

In some embodiments a graphical user interface (GUI) is presented on the game device, and/or some other computer device such as a personal computer, laptop, smart phone, or tablet. Inputs received from the GUI, for example as operated by the game player, may allow the game device to position collected game items within the collection area, as well as in some embodiments generally furnish and decorate the collection area. The GUI, or another GUI, may also allow for display of views of the collected game items from various locations within the collection area. In some embodiments, the collected game items may be sorted or arranged according to one or more attributes of the game items. For example, game items may be sorted or arranged by the items' acquisition dates, rarity, type, value, or any other item attribute or combination of item attributes.

In embodiments, a game player's collection area is accessible to others besides the game player, for example, the game player's in-game friends, social network contacts, anyone who player of the game, the public at large. Access to a game player's collection area may be customized by the game player (e.g., full public access, no public access, or any level in between).

The collection area may be accessible from with the video game or from an interface external to the video game (e.g., a website or mobile app related to the video game).

In some embodiments, the video game comprises an economy engine that allows game players to trade or exchange their game items with others. The economy engine may comprise a GUI that allows game players to barter and make offers for others' game items. In some embodiments, game items can be redeemed for in-game benefits like points or virtual currency.

In some embodiments, benefits may be awarded to a player for collecting a predefined plurality of game items. The predefined plurality of game items may, in some embodiments, be specific game items. In other embodiments, the predefined plurality of game items may be items meeting certain criteria. In some embodiments, the predefined plurality of game items may only be obtainable by playing in certain predefined tournaments (for example as discussed in more detail below), by playing at certain predefined times, and/or by playing certain predefined maps or levels.

In some embodiments the video game may be utilized in a tournament of video games, which in some embodiments may include play of sequential instantiations of the video game. Scores and/or outcomes of the play of the sequential instantiations of the video game may be summed or otherwise combined, for example to determine overall leaders over time. In some embodiments adjunct games may also be used in determining scores, or in otherwise providing bonuses that may be used or useful in play of the video game.

In some embodiments, a tournament of video games may culminate in one or more final contests to determine one or more final winners of the tournament of video games. In some embodiments, limited game items may be obtainable in a tournament of video games and/or in certain contests within the tournament (e.g., certain final contests) that are not otherwise obtainable outside of the tournament of video games. These limited game items may be considered rare or valuable relative to other game items. Limited game items may also be distinguished from other game items in a game player's collection area in any number of ways, including without limitation, by location of storage, manner of presentation (e.g., larger size, rendering effects, animations, design of display case or display room, etc.).

In various embodiments different adjunct games may be used. In some embodiments a geocaching adjunct game may be used. In some geocaching games, game players may use mobile devices with geo-location features to visit place of game play interest. The mobile devices may be, for example, smart phones or tablets with wireless communication capabilities, in some embodiments including cellular communications capabilities. The geo-location features may include GPS circuitry of the mobile devices. In some embodiments the mobile devices report their location to a server, along with an identifier of the mobile device and/or game player. The server may determine or keep track of particular game play related locations visited by the mobile device, for use in providing video game play bonuses or score adjustments for game players.

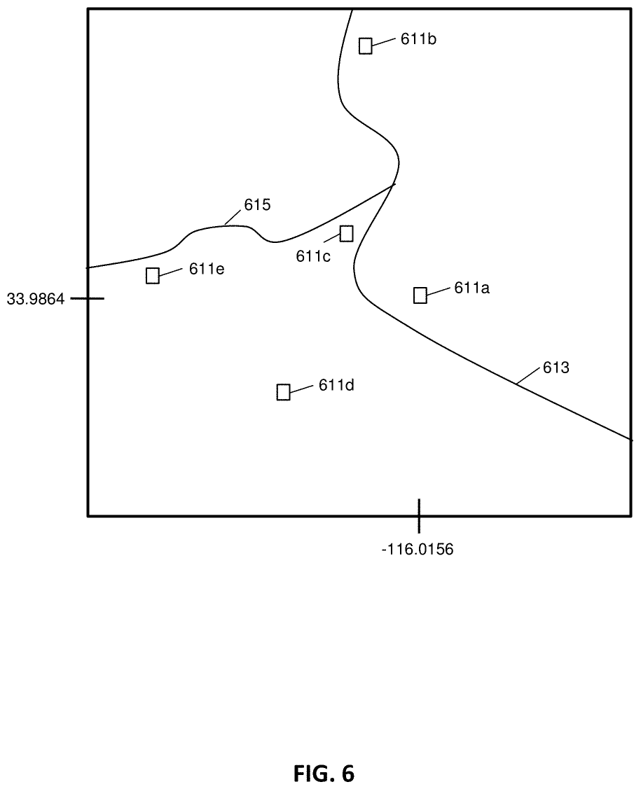

FIG. 6 is a map of for a geocaching adjunct game, in accordance with aspects of the invention. The map includes a plurality of locations 611a-e for game players to visit. A first location 611a is east of a generally north-southeast trending road 813. The map shows the first location at 33.9864 digital degrees latitude and −116.0156 digital degrees longitude. A second location 611b is slightly east of the road 613. A third location 611c is slightly southwest of an intersection between the road 613 and a generally east-west road 615, which terminates at the road 613. A fourth location 611d is south of the third location. A fifth location 611e is slightly south of the road 615. Each of the locations may have a virtual item that game players may collect by visiting the location, as determined by the geo-location features of the mobile devices. In some embodiments each virtual item may only be collected by one game player, in some embodiments each virtual item may be collected by a predetermined number of game players, or any number of game players. In some embodiments a score or bonus is provided based on a number and/or type of virtual items collected by a game player.

Although the invention has been discussed with respect to various embodiments, it should be recognized that the invention comprises the novel and non-obvious claims supported by this disclosure.

What is claimed is:

1. A method of concentrating game play of a video game, comprising:
determining a metric associated with passage of game characters past at least one gating construct in play of a video game;
based on the metric, determining a subset of the game characters to continue in play of the video game; and
continuing to provide for play of the video game with game characters that are in the subset of the game characters and discontinuing providing play of the video game with game characters that are not in the subset of game characters.

2. The method of claim 1, wherein the gating construct is a video game gate.

3. The method of claim 2, wherein a game character of the game characters may only pass through the gate with possession of a predetermined video game relic.

4. The method of claim 3, wherein at least some of the game characters, including the game character of the game characters, form a team of game characters, and game characters other than the game character may only pass through the gate after passage through the gate of the game character with possession of the predetermined video game relic.

5. The method of claim 1, wherein the gating construct is a video game obstacle.

6. The method of claim 1, wherein the metric is a number of game characters that have passed the at least one gating construct.

7. The method of claim 1, wherein the at least one gating construct comprises a plurality of gating constructs, and the metric is associated with passage of game characters past any of the plurality of gating constructs.

8. The method of claim 1, wherein the subset of the game characters to continue play of the video game are a first predetermined number of game characters that have passed the at least one gating construct.

9. The method of claim 1, wherein the subset of the game characters to continue play of the video game are a first predetermined number of game characters that have passed the at least one gating construct and game characters on a same team as game characters of the first predetermined number of game characters that have passed the at least one gating construct.

10. A method of modifying a map of a video game world during play of a video game, comprising:
determining that a map modification triggering event has occurred during play of a video game, the video game providing play in a video game world; and
in response to determining that the map modification triggering event has occurred, successively making unplayable interior-most playable areas of portions of the video game world.

11. The method of claim 10, wherein the interior-most playable areas of portions of the video game world are made unplayable through removal of the interior-most playable areas from the video game world.

12. The method of claim 10, wherein the interior-most playable areas of portions of the video game world are made unplayable through introduction of an invincible game-controlled character in the interior-most playable areas.

13. The method of claim 10, wherein the interior-most playable areas of portions of the video game world are made unplayable by making the interior-most playable areas not available to game characters.

14. The method of claim 10, wherein successively making unplayable interior-most playable areas of portions of the video game world comprises making a most interior of the interior-most playable areas not available to game characters and subsequently making a next-most interior-most of the interior-most playable areas not available to game characters.

15. The method of claim 14, wherein the most interior of the interior-most playable areas comprise a central area of an island, and the next-most interior-most of the interior-most playable areas comprises an area forming a ring around the central area of the island.

16. The method of claim 15, wherein the interior-most playable areas comprise the island.

17. The method of claim 15, wherein the playable areas comprise the island.
